(19) United States
(12) Patent Application Publication
(10) Pub. No.: US 2014/0237221 A1
(43) Pub. Date: Aug. 21, 2014

(54) APPLICATION EXECUTION ENVIRONMENT SETTING APPARATUS AND METHOD FOR MOBILE TERMINAL

(71) Applicant: Samsung Electronics Co., Ltd., Suwon-si (KR)

(72) Inventors: Junyong CHOI, Suwon-si (KR); Jeongmin PARK, Suwon-si (KR); Jaewoong CHUN, Suwon-si (KR)

(73) Assignee: Samsung Electronics Co., Ltd., Suwon-si (KR)

(21) Appl. No.: 14/180,863

(22) Filed: Feb. 14, 2014

(30) Foreign Application Priority Data
Feb. 15, 2013 (KR) 10-2013-0016399

(51) Int. Cl. G06F 9/445

(52) U.S. Cl. CPC G06F 9/44505
USPC 713/1

(57) ABSTRACT

An apparatus and method for application execution environment setting in a mobile terminal are provided. The application execution environment setting apparatus configures application execution environment variables on a per application basis in consideration of variable values assigned by the user in the past.

### CROSS-REFERENCE TO RELATED APPLICATION(S)

This application claims the benefit under 35 U.S.C. §119(a) of a Korean patent application filed on Feb. 15, 2013 in the Korean Intellectual Property Office and assigned Serial No. 10-2013-0016399, the entire disclosure of which is hereby incorporated by reference.

### TECHNICAL FIELD

The present disclosure relates to an application execution environment setting apparatus and method for a mobile terminal. More particularly, the present disclosure relates to an application execution environment setting apparatus and method for a mobile terminal wherein application execution environment variables are set on a per application basis in consideration of variable values assigned by the user in the past.

### BACKGROUND

In a mobile terminal, environment settings are commonly applied to all applications, or pre-configured settings may be applied to a particular application. Hence, when the user changes environment variables in an application being executed, the changed environment variables may be applied to other applications that are executed later. Thereby, the user may be inconvenienced by having to change environment variables for each application to be executed.

Accordingly there is a need for an to provide an application execution environment setting apparatus and method for a mobile terminal wherein application execution environment variables are configured on a per application basis in consideration of values assigned by the user in the past.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above mentioned problems and/or disadvantages and to provide at least the advantages described below. Accordingly, an aspect of the present disclosure is to provide an application execution environment setting apparatus and method for a mobile terminal wherein application execution environment variables are configured on a per application basis in consideration of values assigned by the user in the past.

In accordance with an aspect of the present disclosure, an apparatus for application execution environment setting in a mobile terminal is provided. The apparatus may include a storage unit configured to store past environment configuration data composed of environment setting values that have been used by applications executed in the past and are arranged on an application basis, and a control unit configured to configure, when an application is executed, application environment variables for the application on a basis of the past environment configuration data.

In accordance with another aspect of the present disclosure, a method for application execution environment setting in a mobile terminal is provided. The method may include executing an application and configuring, when the application is executed, application environment variables for the application on a basis of past environment configuration data composed of environment setting values that have been used by applications executed in the past and are arranged on an application basis.

In a feature of the present disclosure, when an application is executed, execution environment variables for the application are configured on the basis of previous environment setting data. Hence, an application-specific execution environment may be provided so as to increase user convenience. In addition, environment variables related to screen brightness, screen off time, GPS usage, Wi-Fi usage and Bluetooth usage may be configured on a per application basis, decreasing unnecessary current consumption.

Further, when a running application is scheduled to play digital content, content playback settings are configured on the basis of previous playback setting data. Hence, a content-specific playback environment may be provided so as to increase user convenience. In addition, playback variables such as loudness may be configured according to content types, contributing to prevention of accidental hearing damage. For example, as classical music and rock music having the same sound volume may have different effects on hearing damage, configuration of playback variables based on content types may be beneficial to prevention of accidental hearing damage.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of a mobile terminal according to an embodiment of the present disclosure;

FIG. 2 is a flowchart of a procedure for configuring application execution environment variables according to an embodiment of the present disclosure;

FIG. 3 is a detailed flowchart of an execution environment setting operation in the procedure of FIG. 2 according to an embodiment of the present disclosure;

FIG. 4 is a flowchart of a procedure for configuring content playback environment variables according to an embodiment of the present disclosure; and

FIG. 5 is a detailed flowchart of a content playback setting operation in the procedure of FIG. 4 according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

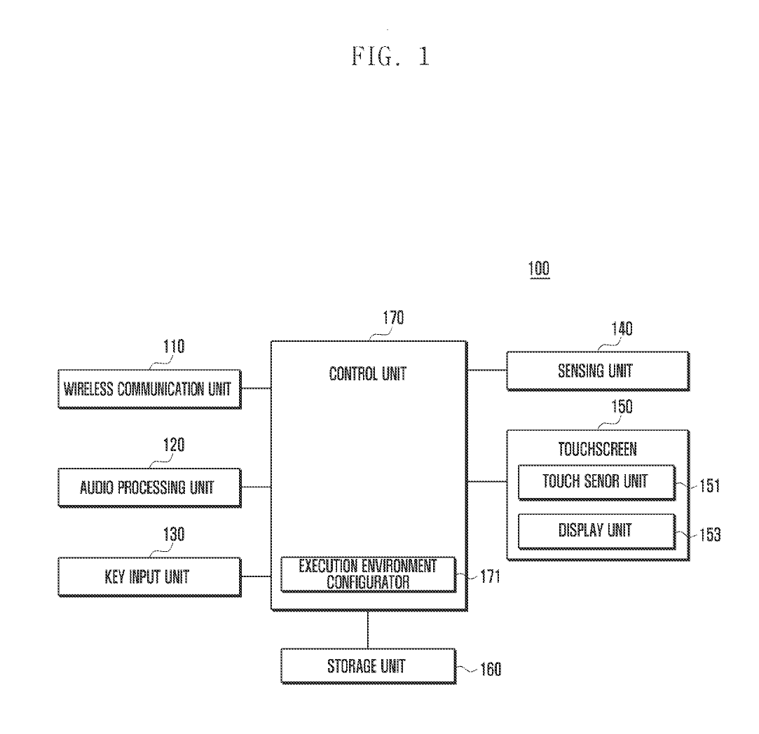

FIG. 1 is a block diagram of a mobile terminal 100 according to an embodiment of the present disclosure.

Referring to FIG. 1, the mobile terminal 100 may include a wireless communication unit 110, an audio processing unit 120, a key input unit 130, a sensing unit 140, a touchscreen 150, a storage unit 160, and a control unit 170.

The wireless communication unit 110 performs data transmission and reception for wireless communication of the mobile terminal 100. The wireless communication unit 110 may include a Radio Frequency (RF) transmitter for upconverting the frequency of a signal to be transmitted and amplifying the signal, and a radio frequency receiver for low-noise amplifying a received signal and downconverting the frequency of the received signal. The wireless communication unit 110 may receive data through a radio channel and forward the data to the control unit 170, and may transmit data from the control unit 170 through a radio channel.

The audio processing unit 120 may include a coder/decoder (codec). The codec may have a data codec for processing packet data and the like, and an audio codec for processing an audio signal such as a voice signal. The audio processing unit 120 converts a digital audio signal into an analog audio signal through the audio codec to reproduce the analog audio signal through a speaker, and converts an analog audio signal from a microphone into a digital audio signal through the audio codec.

The key input unit 130 may generate an input signal corresponding to user key manipulation for controlling the mobile terminal 100 and send the input signal to the control unit 170. The key input unit 130 may include a keypad composed of numeric keys and direction keys, and function keys formed on a side of the mobile terminal 100. The mobile terminal 100 may be fully manipulated for embodiments of the present disclosure using only the touchscreen 150, allowing the key input unit 130 to be omitted.

The sensing unit 140 may sense states of the mobile terminal 100. The sensing unit 140 may sense the state of the mobile terminal 100 and send sensed data to the control unit 170. To achieve this, the sensing unit 140 may include an illumination sensor, proximity sensor, acceleration sensor, motion sensor, geomagnetic sensor, temperature sensor, humidity sensor, atmospheric pressure sensor, pressure sensor, gravity sensor, and the like. In particular, the sensing unit 140 may include a satellite signal reception module (not shown) to identify the location of the mobile terminal 100.

The touchscreen 150 includes a touch senor unit 151 and a display unit 153. The touch senor unit 151 and the display unit 153 may form a layered structure. The touch senor unit 151 may sense a change in pressure or capacitance at a portion of the display unit 153 and convert the sensed change into an electrical signal. The touch senor unit 151 may detect the position, area and pressure of a touch.

That is, the touch senor unit 151 may sense user touch input, generate a sensing signal corresponding to the touch input, and send the sensing signal to the control unit 170. The sensing signal includes coordinate data of touch input. When the user makes a touch and move gesture, the touch senor unit 151 may generate a sensing signal containing coordinate data of the touch and movement path and send the sensing signal to the control unit 170.

The touch senor unit 151 may include a touch sensor using capacitive overlay, resistive overlay, surface acoustic wave or infrared beams, or a pressure sensor. A sensor of any type capable of sensing contact with an object or pressure caused by an object may be included in the touch senor unit 151.

The display unit 153 provides the user with various visual information such as menus of the mobile terminal 100, input data, and function setting information. The display unit 153 may output a boot screen, standby screen, menu screen, call handling screen, and application screen for the mobile terminal 100.

The display unit 153 may be realized using Liquid Crystal Display (LCD) devices, Organic Light Emitting Diodes (OLED), Active Matrix Organic Light Emitting Diodes (AMOLED), flexible display, or 3D display.

The storage unit 160 may store programs and data necessary for operation of the mobile terminal 100, and may be divided into a program section and a data section. The program section may store a program for controlling the overall operation of the mobile terminal 100, an Operating System (OS) for booting the mobile terminal 100, an application program for playing multimedia content, and other application programs for optional functions of the mobile terminal 100 such as voice conversation, camera function, sound reproduction, image or moving image playback. The data section may store data generated in the course of using the mobile terminal 100, such as images, moving images, phonebook entries and audio data.

The control unit 170 controls overall operation of individual components of the mobile terminal 100. The control unit 170 configures application execution environment variables on a per application basis in consideration of values having been assigned by the user in the past. Applications are programs that are installed and executed in the mobile terminal 100, such as a call handling application, message handling application, and a multimedia playback application. The control unit 170 may include an execution environment configurator 171.

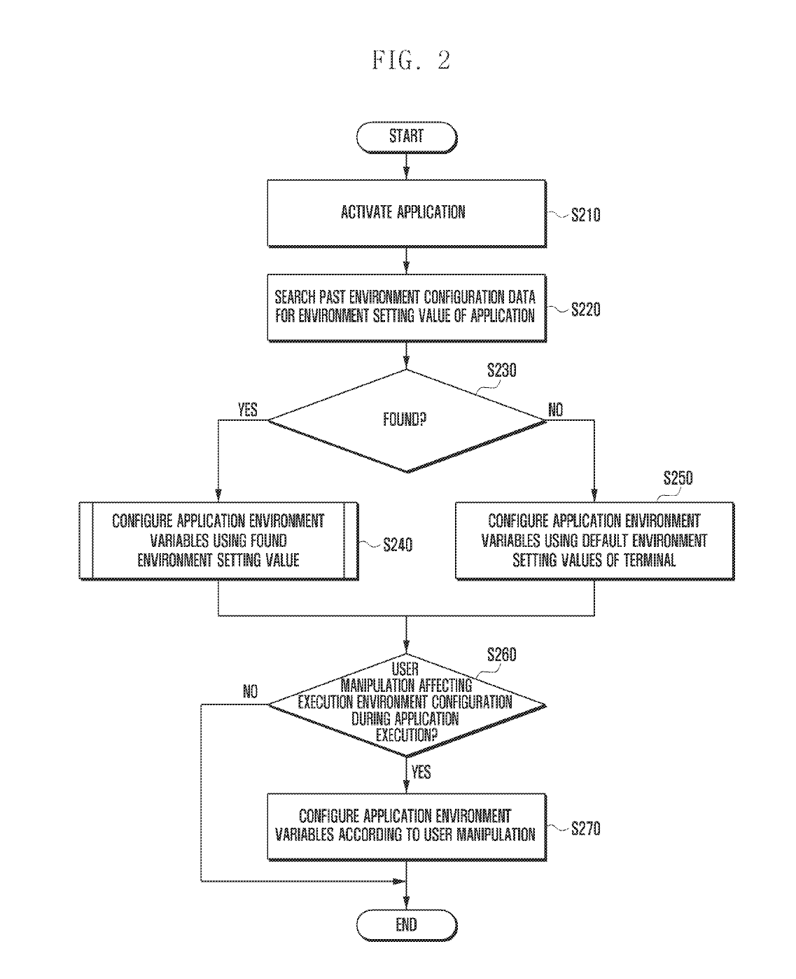

FIG. 2 is a flowchart of a procedure for configuring application execution environment variables according to an embodiment of the present disclosure.

Referring to FIG. 2, at operation S210, an application is activated according to user manipulation. At operation S220, the execution environment configurator 171 searches the past environment configuration data stored in the storage unit 160 for a previous environment setting value of the application. The past environment configuration data is composed of environment setting values that have been assigned by individual applications executed in the past and are arranged on a per application basis. That is, the past environment configuration data may include fields for recording application identification information, environment setting values assigned by user manipulation, setting date and time, the location of the mobile terminal 100 at the time of setting, and the like. For example, the past environment configuration data may include a plurality of entries as shown in Table 1.

TABLE 1

| Application | | Location at the | Setting |
|---|---|---|---|
| ID | Setting date and time | time of setting | value |
| APP_1 | 2012-12-28 15:00 | Location_A | Setting_1 |
| APP_1 | 2012-12-30 20:30 | Location_B | Setting_2 |
| APP_2 | 2012-12-31 21:00 | Location_C | Setting_3 |
| APP_1 | 2013-01-03 11:00 | Location_A | Setting_4 |
| APP_2 | 2013-01-04 10:30 | Location_A | Setting_5 |

User-configurable environment variables may include default environment variables provided by the mobile terminal 100 and application specific environment variables. Examples of default environment variables may be parameters related to screen brightness, screen off time, usage of rotation lock, screen orientation, font, font size, keyboard type, keyboard language, sound volume, usage of vibration, call reception indication, message reception indication, usage of GPS, usage of Wi-Fi, usage of Bluetooth, usage of motion sensing, security level, and the like. Examples of application specific environment variables may be parameters related to base channels (radio or TV application), equalization (music application), and the like.

At operation S230, the execution environment configurator 171 checks whether a previous environment setting value of the application is found. If a previous environment setting value of the application is found, the execution environment configurator 171 proceeds to operation S240 at which the environment configurator 171 may set the corresponding environment variable to the previous environment setting value. At operation S240, the execution environment configurator 171 may automatically configure the application environment variables on the basis of the found previous environment setting value. Alternatively, the execution environment configurator 171 may recommend application environment settings based on the found previous environment setting value to the user through a notification window. When the recommendation is accepted by the user, the execution environment configurator 171 may configure the application environment variables on the basis of the found previous environment setting value. When the difference between the current date and time and the date and time of the previous environment setting is greater than or equal to a configurable duration (e.g. two weeks), the execution environment configurator 171 may configure the application environment variables on the basis of the found previous environment setting value or default environment setting values of the mobile terminal 100 stored in the storage unit 160. The execution environment configurator 171 may recommend application environment settings based on the found previous environment setting value to the user through a notification window. When the recommendation is accepted by the user, the execution environment configurator 171 may configure the application environment variables on the basis of the found previous environment setting value. When the recommendation is rejected by the user, the execution environment configurator 171 may configure the application environment variables on the basis of the default environment setting values of the mobile terminal 100.

If a previous environment setting value of the application is not found at operation S230, the execution environment configurator 171 proceeds to operation S250 at which the execution environment configurator 171 may configure the application environment variables on the basis of the default environment setting values of the mobile terminal 100 stored in the storage unit 160.

During application execution, at operation S260, the execution environment configurator 171 may check whether user manipulation affecting the execution environment configuration is generated. If user manipulation affecting the execution environment configuration is generated, the execution environment configurator 171 proceeds to operation S270 at which the execution environment configurator 171 may configure the application environment variables according to user manipulation. User manipulation may correspond to a key press on the key input unit 130, a touch gesture on the touchscreen 150, or rotation of the mobile terminal 100. For example, in a state wherein the screen is dimmed after passage of a preset time during which no user input has been generated, when a user key input or touch gesture is generated, the execution environment configurator 171 may configure the application environment variables so that the screen becomes bright again.

During application execution, the execution environment configurator 171 may repeatedly configure the application environment variables according to user manipulation. For example, when no user input is generated for a preset time, the execution environment configurator 171 may configure the application environment variables so that the screen is dimmed. Upon generation of a user key input or touch gesture in a state wherein the screen is dim, the execution environment configurator 171 may configure the application environment variables so that the screen becomes bright. When no user input is generated for a preset time, the execution environment configurator 171 may configure the application environment variables so that the screen is dimmed again.

When the application environment variables are reconfigured, the execution environment configurator 171 may add the corresponding environment setting values to the past environment configuration data stored in the storage unit 160. When an application is uninstalled from the mobile terminal 100, the execution environment configurator 171 may remove environment setting values associated with the uninstalled application from the past environment configuration data.

In the above description, the application environment variables are configured according to user manipulation. However, the present disclosure is not limited thereto. The application environment variables may also be configured in a multitasking environment where multiple applications are executed at the same time. For example, when an application running in the background is brought to the foreground according to user manipulation, the environment variables of the application may be configured on the basis of the past environment configuration data.

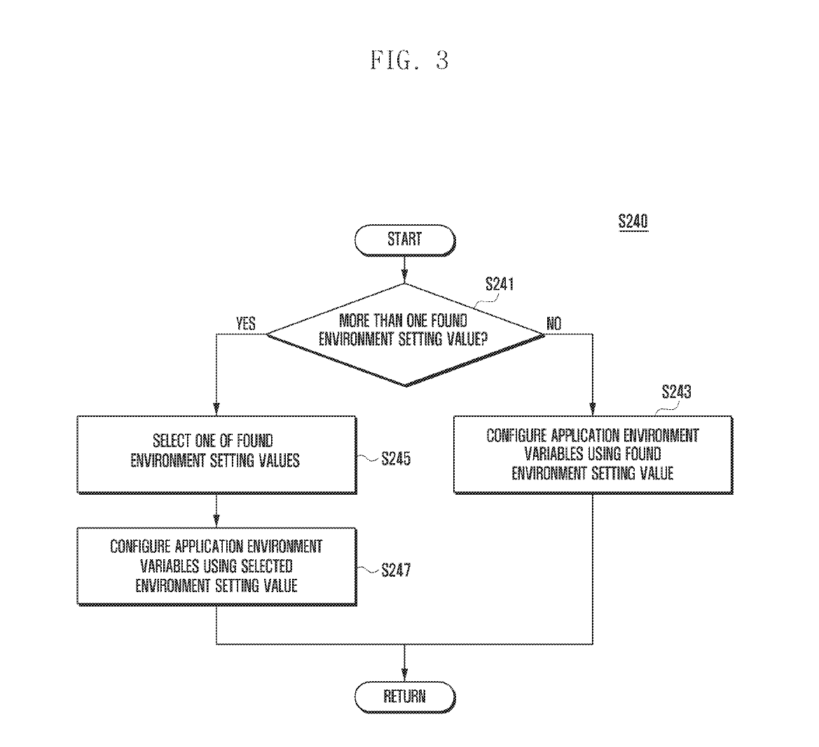

FIG. 3 is a detailed flowchart of an execution environment setting operation in the procedure of FIG. 2 according to an embodiment of the present disclosure.

Referring to FIG. 3, at operation S241, the execution environment configurator 171 may check whether more than one previous environment setting value of the application is found. If more than one previous environment setting value of the application is found, the execution environment configurator 171 may proceed to operation S245 at which the execution environment configurator 171 may select one of the found previous environment setting values.

Specifically, the execution environment configurator 171 may select the most recent one of the previous environment setting values. For example, assume that the past environment configuration data is given by Table 1 and an application with identification information “APP_{—}1” is executed by the user. Three previous environment setting values are found for the application APP_{—}1. Among the three previous environment setting values, the execution environment configurator 171 may select the most recent setting value “Setting_{—}4” whose setting date and time is “2013-01-03 11:00”.

The execution environment configurator 171 may select one of previous environment setting values according to whether the current time is within regular business hours. For example, assume that the past environment configuration data is given by Table 1 and an application with identification information “APP_{—}1” is executed at “2013-01-08 21:00”. Three previous environment setting values are found for the application APP_{—}1. As the current time (2013-01-08 21:00) is not within regular business hours (09:00 to 19:00), among the three previous environment setting values, the execution environment configurator 171 select the setting value “Setting_{—}2”, whose setting date and time “2012-12-30 20:30” does not belong to the regular business hours. In addition to business hours, one of multiple previous environment setting values may be selected according to other criteria, such as the day of the week, and holidays. When multiple previous environment setting values are selectable with respect to the current date and time, the execution environment configurator 171 may select the most recent one of these setting values.

The execution environment configurator 171 may select one of previous environment setting values according to the current location of the mobile terminal 100. For example, assume that the past environment configuration data is given by Table 1 and an application with identification information “APP_{—}2” is executed at a location “Location_C”. Two previous environment setting values are found for the application APP_2. As the current location is “Location_C”, the execution environment configurator 171 may select the setting value “Setting_{—}3” whose location at the time of setting is “Location_C” from among the two setting values.

At operation S247, the execution environment configurator 171 configures the application environment variables on the basis of the selected previous environment setting value.

If only one previous environment setting value is found for the application at operation S241, the execution environment configurator 171 may proceed to operation S243 at which the execution environment configurator 171 may configure the application environment variables on the basis of the found previous environment setting value.

In the above description, the execution environment configurator 171 is depicted as selecting one of previous environment setting values according to the most recent date and time, relatedness to the current date and time, or the current location of the mobile terminal 100. However, the execution environment configurator 171 may also select one of previous environment setting values according to a combination of the above criteria.

Further, the execution environment configurator 171 may assign weightings to previous environment setting values and select one of the previous environment setting values according to the weightings. The weightings may be determined according to closeness to the current date and time. For example, a high weighting may be assigned to a previous environment setting value whose date and time of setting is close to the current date and time, and a low weighting may be assigned to a previous environment setting value whose date and time of setting is far from the current date and time.

As described above, when an application is executed, execution environment variables for the application are separately configured on the basis of the previous environment setting data. Hence, an application-specific execution environment may be provided so as to increase user convenience.

In addition, environment variables related to screen brightness, screen off time, GPS usage, Wi-Fi usage and Bluetooth usage may be configured on a per application basis, decreasing unnecessary current consumption.

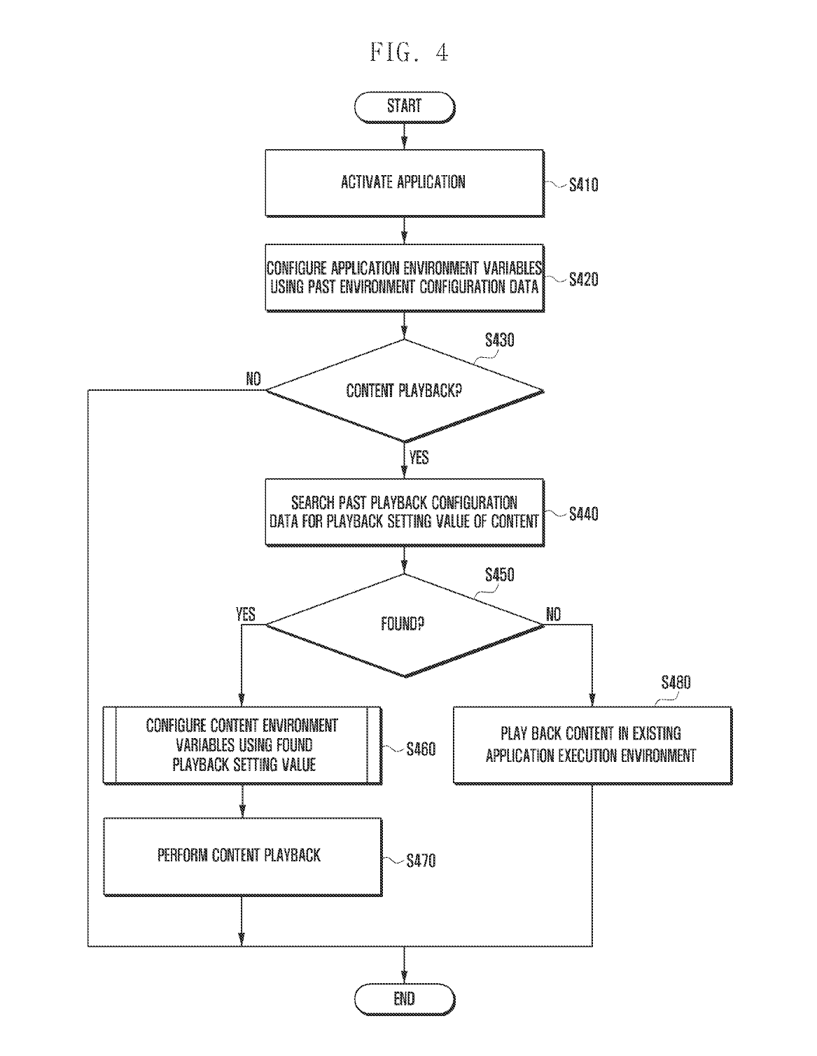

FIG. 4 is a flowchart of a procedure for configuring content playback environment variables according to an embodiment of the present disclosure.

Referring to FIG. 4, at operation S410, an application is activated according to user manipulation. At operation S420, the execution environment configurator 171 may configure the application environment variables on the basis of the past environment configuration data stored in the storage unit 160. As described before, the execution environment configurator 171 may search the past environment configuration data for a previous environment setting value of the application and set the corresponding environment variable to the found previous environment setting value.

At operation S430, the execution environment configurator 171 checks whether the application initiates content playback according to user manipulation. If the application initiates content playback, the execution environment configurator 171 may proceed to operation S440 at which the execution environment configurator 171 may search the past playback configuration data stored in the storage unit 160 for a previous playback setting value related to the content. Content refers to multimedia content such as music, movie, video, electronic books or electronic documents. The past playback configuration data is composed of playback setting values that have been assigned by applications executed in the past and are arranged on a content type basis. Content may be classified according to attributes thereof. For example, music content may, for example, be classified by genre into one of classical, pop, rock, and rhythm and blues (R&B).

That is, the past playback configuration data may include fields for recording application identification information, content type, playback setting values assigned by user manipulation, setting date and time, the location of the mobile terminal 100 at the time of setting, and the like. For example, the past playback configuration data may include a plurality of entries as shown in Table 2.

TABLE 2

| Application ID | Setting date and time | Location at the time of setting | Content type | Playback setting value |
|---|---|---|---|---|
| APP_1 | 2012-12-28 15:00 | Location_A | Music_Pop | Content_Setting_1 |
| APP_1 | 2012-12-30 20:30 | Location_B | Music_Rock | Content_Setting_2 |
| APP_2 | 2012-12-31 21:00 | Location_C | Video_Action | Content_Setting_3 |
| APP_1 | 2013-01-03 11:00 | Location_A | Music_R&B | Content_Setting_4 |
| APP_2 | 2013-01-04 10:30 | Location_A | Video_Drama | Content_Setting_5 |

Content environment variables may include default environment variables for functions provided by the mobile terminal 100 and environment variables for functions provided by applications.

The past playback configuration data and the past environment configuration data may be separately stored in the storage unit 160. Alternatively, the past playback configuration data may be stored as a portion of the past environment configuration data. In this case, the “content type” and “playback setting value” fields of the past playback configuration data may be included in the “setting value” field of the past environment configuration data.

For example, assume that the past playback configuration data is given by Table 2 and an application with identification information “APP_{—}1” is executed by the user to play content of type “Music_Pop”. The execution environment configurator 171 may find a previous playback setting value “Content_Setting_{—}1” for the content type “Music_Pop” in the past playback configuration data.

At operation S450, the execution environment configurator 171 may check whether at least one previous playback setting value is found. If at least one previous playback setting value is found, the execution environment configurator 171 may proceed to operation S460 at which the execution environment configurator 171 may configure the content environment variables on the basis of the found previous playback setting value. At operation S470, the execution environment configurator 171 plays back the content through the audio processing unit 120 and the display unit 153.

If no previous playback setting value is found at operation S450, the execution environment configurator 171 may proceed to operation S480 at which the execution environment configurator 171 may play back the content through the audio processing unit 120 and the display unit 153 in the existing application execution environment.

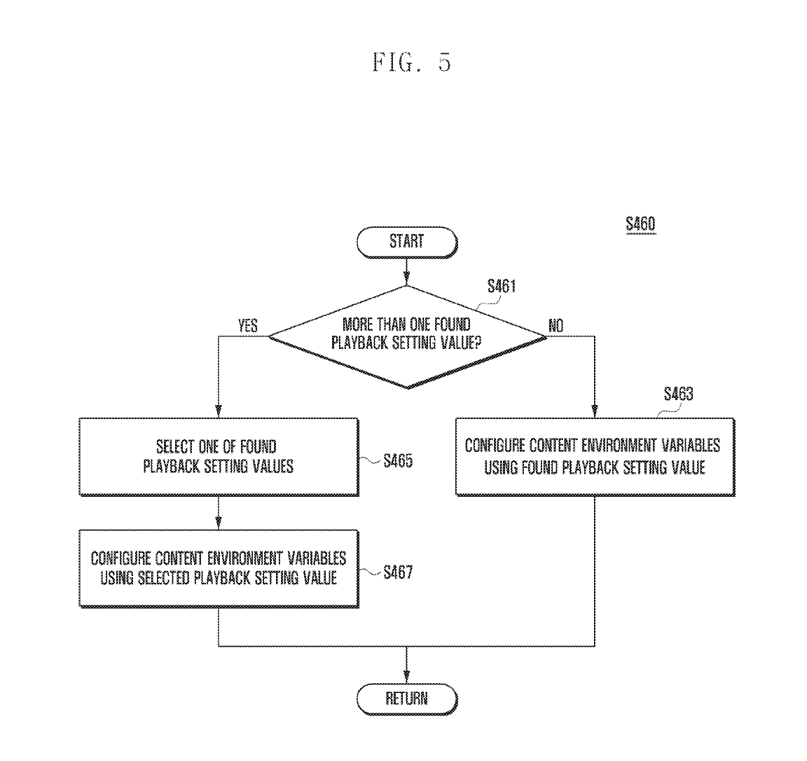

FIG. 5 is a detailed flowchart of a content playback setting operation in the procedure of FIG. 4 according to an embodiment of the present disclosure.

Referring to FIG. 5, at operation S461, the execution environment configurator 171 may check whether more than one previous playback setting value for the application is found. If more than one previous playback setting value is found, the execution environment configurator 171 may proceed to operation S465 at which the execution environment configurator 171 may select one of the found previous playback setting values. For example, the execution environment configurator 171 may select the most recent one of the previous playback setting values. The execution environment configurator 171 may also select one of the previous playback setting values on the basis of the current date and time or the current location of the mobile terminal 100.

At operation S467, the execution environment configurator 171 may configure the content environment variables on the basis of the selected previous playback setting value.

If only one previous environment setting value is found at operation S461, the execution environment configurator 171 may proceed to operation S463 at which the execution environment configurator 171 may configure the content environment variables on the basis of the found previous playback setting value.

As described above, when a running application is scheduled to play digital content, content playback settings are configured on the basis of previous playback setting data. Hence, a content-specific playback environment may be provided to thereby increase user convenience.

In addition, content playback variables such as sound volume may be separately configured according to content types, contributing to prevention of accidental hearing damage. For example, as classical music and rock music having the same sound volume may have different effects on hearing damage, configuration of playback variables based on content types may be beneficial to prevention of accidental hearing damage.

In the above description, the execution environment configurator 171 is depicted as a separate entity from the control unit 170. However, this separation is only for ease of description. For example, the control unit 170 may directly perform the function of the execution environment configurator 171.

Various aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include Read-Only Memory (ROM), Random-Access Memory (RAM), CD-ROMs, magnetic tapes, floppy disks, and optical data storage devices. The non-transitory computer readable recording medium can also be distributed over network coupled computer systems so that the computer readable code is stored and executed in a distributed fashion. Also, functional programs, code, and code segments for accomplishing the present disclosure can be easily construed by programmers skilled in the art to which the present disclosure pertains.

At this point it should be noted that various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include Read-Only Memory (ROM), Random-Access Memory (RAM), CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present disclosure can be easily construed by programmers skilled in the art to which the present disclosure pertains.

While the present disclosure has been shown and described with reference to various embodiments thereof, it should be understood by those skilled in the art that various changes in form and details may be made therein without departing from the spirit and scope of the present disclosure as defined by the appended claims and their equivalents.

What is claimed is:

1. An apparatus for application execution environment setting in a mobile terminal, the apparatus comprising:
a storage unit configured to store past environment configuration data composed of environment setting values that have been used by applications executed in the past and are arranged on an application basis; and
a control unit configured to configure, when an application is executed, application environment variables for the application on a basis of the past environment configuration data.

2. The apparatus of claim 1, wherein, when the application is executed, the control unit searches the past environment configuration data stored in the storage unit for a previous environment setting value related to the application, and automatically configures the application environment variables for the application using one of the previous environment setting value that are found and recommends configuration of the application environment variables using the previous environment setting value that are found.

3. The apparatus of claim 1, wherein, when the application is executed, the control unit searches the past environment configuration data stored in the storage unit for a previous environment setting value related to the application, and configures, when more than one previous environment setting value is found, the application environment variables for the application using a most recent one of the previous environment setting values that are found.

4. The apparatus of claim 1, wherein, when the application is executed, the control unit searches the past environment configuration data stored in the storage unit for a previous environment setting value related to the application, selects, when more than one previous environment setting value is found, one of the previous environment setting values that are found on a basis of one of (i) a current date and time and (ii) a current location of the mobile terminal, and configures the application environment variables for the application using the selected previous environment setting value.

5. The apparatus of claim 1, wherein, when the application is executed, the control unit searches the past environment configuration data stored in the storage unit for a previous environment setting value related to the application, and configures, when the difference between the current date and time and the date and time of the previous environment setting value is greater than or equal to a preset duration, the application environment variables for the application on a basis of one of the previous environment setting value that are found and a default environment setting value of the mobile terminal.

6. The apparatus of claim 1, wherein, when a user gesture affecting execution environment configuration is generated during application execution, the control unit configures the application environment variables for the application according to the user gesture.

7. The apparatus of claim 6, wherein, when a user gesture affecting execution environment configuration is repeatedly generated during application execution, the control unit repeatedly configures the application environment variables for the application in accordance with repetition of the user gesture.

8. The apparatus of claim 1, wherein the storage unit further stores past playback configuration data composed of playback setting values that have been used by applications playing content executed in the past and are arranged on a content type basis, and wherein, when the application is executed and plays back content, the control unit configures content environment variables for the content on a basis of the past playback configuration data.

9. A method for application execution environment setting in a mobile terminal, the method comprising:
executing an application; and
configuring, when the application is executed, application environment variables for the application on a basis of past environment configuration data composed of environment setting values that have been used by applications executed in the past and are arranged on an application basis.

10. The method of claim 9, wherein the configuring of the application environment variables comprises searching, when the application is executed, the past environment configuration data for a previous environment setting value related to the application, and automatically configuring the application environment variables for the application using one of the previous environment setting value that are found and recommending configuration of the application environment variables using the previous environment setting value that are found.

11. The method of claim 9, wherein the configuring of the application environment variables comprises searching, when the application is executed, the past environment configuration data for a previous environment setting value related to the application, and configuring, when more than one previous environment setting value is found, the application environment variables for the application using a most recent one of the previous environment setting values that are found.

12. The method of claim 9, wherein the configuring of the application environment variables comprises searching, when the application is executed, the past environment configuration data for a previous environment setting value related to the application, selecting, when more than one previous environment setting value is found, one of the previous environment setting values that are found on a basis of one of (i) a current date and time and (ii) a current location of the mobile terminal, and configuring the application environment variables for the application using the selected previous environment setting value.

13. The method of claim 9, wherein the configuring of the application environment variables comprises searching, when the application is executed, the past environment configuration data for a previous environment setting value related to the application, and configuring, when the difference between the current date and time and the date and time of the previous environment setting value is greater than or equal to a preset duration, the application environment variables for the application on a basis of one of the previous environment setting value that are found and a default environment setting value of the mobile terminal

14. The method of claim 9, wherein the configuring of the application environment variables comprises configuring, when a user gesture affecting execution environment configuration is generated during application execution, the application environment variables for the application according to the user gesture.

15. The method of claim 14, wherein the configuring of the application environment variables comprises repeatedly configuring, when a user gesture affecting execution environment configuration is repeatedly generated during application execution, the application environment variables for the application in accordance with repetition of the user gesture.

16. The method of claim 9, further comprising configuring, when the application is executed and plays back content, content environment variables for the content on a basis of past playback configuration data composed of playback setting values that have been used by applications playing content executed in the past and are arranged on a content type basis.

17. The method of claim 16, wherein the content type is one of a genre of content recorded on a plurality of media.

18. A non-transitory computer-readable storage medium storing instructions that, when executed, cause at least one processor to perform the method of claim 9.
